(19) United States
(12) Patent Application Publication
(10) Pub. No.: US 2005/0071750 A1
(43) Pub. Date: Mar. 31, 2005

(54) Method and system for automated metamodel system file generation

(76) Inventor: Brent Dalmas Nelson, Plano, TX (US)

Correspondence Address: FORTKORT GRETHER + KELTON LLP, 8911 N. CAPITAL OF TEXAS HWY., SUITE 3200, AUSTIN, TX, 78759, US

(21) Appl. No.: 10/675,123

(22) Filed: Sep. 30, 2003

(51) Int. Cl. G06F 15/00

(52) U.S. Cl. 715/503

(57) ABSTRACT

An automated metamodel system file generation method and system (146) generates a plurality of metamodel files (148) using a set of metamodel requirements (144) derived for a metamodel system (180). The invention includes the steps of and instructions for (180, 182) capturing for a metamodel system (80) a set of metamodel requirements (144). The system (146) saves the captured set of metamodel requirements in at least one requirements spreadsheet (152) and then opens (146) the spreadsheet (152) to make accessible the captured set of metamodel requirements. The system (146) further generates at least one each of an object type spreadsheet (192), a relationship type spreadsheet (198), and a symbol type spreadsheet (188) by applying a predetermined set of generation instructions to said at least one requirements spreadsheet (152). From the specified object type spreadsheet (192), relationship type spreadsheet (198), and symbol type spreadsheet (188) the system (146) generates a plurality of metamodel files (148) for use in a metamodel system (80).

### TECHNICAL FIELD OF INVENTION

The invention, in general, relates to a method and system for automated metamodel system mark-up language file generation from a plurality of metamodel system requirements.

### BACKGROUND OF THE INVENTION

Computers are known as effective tools for modeling many types of systems, both physical and organizational. One type of modeling tool is an object-oriented modeling system, which establishes a computer-bused environment replicating an actual environment or interactive system or set of systems. Object-oriented modeling environments constitute object, relationships, and models, which are sets of instances of the object types and relationship types, etc., are implemented in a mark-up language such as XML. One such object-oriented modeling environment is known as on metamodeling environment.

A metamodeling environment enables building models of business processes, such as an enterprise for which an enterprise architecture model may be developed. The metamodel addresses the need to understand increasingly complex enterprises, enabling decision makers and those that carry out the everyday work to share a common understanding, represented as a visual model. The model forms the basis for making informed decisions, since it becomes possible to reveal the complex interplay within the enterprise.

An enterprise architecture model enables the illustration and depiction of enterprises and their ongoing processes, their customers and their suppliers. A metamodeling environment for an enterprise provides an illustrative domain for depicting how processes and relationships within an enterprise interact with one another rise. A desired metamodeling system does not restrict the user to a particular methodology for modeling, but provides templates for the modeling of different domains. The metamodel also permits the near to author directly into the model or import data from other applications, and to analyze models and access data outside of the model.

One aspect of a metamodel environment program is that not only does it provide the ability to model enterprises according to different classes, but also it provides the ability to create entirely new classes of objects. This permits a metamodel model developed using metamodeling software to expand to new processes and new relationships and new features within these relationships that previously may not exist.

The field of enterprise architecture is one in which the strengths of a metamodeling system are clearly seen. In order to optimize the use of information technology by complex, often global organizations, enterprise architects use such a tool to not only can represent complexity, but also to aid in analysis. This allows them to produce output that is intelligible to many different user groups.

Software for these systems permits creating new metamodels using a graphical user interface. While a graphical user the interface may be well suited to metamodel development, a graphical user interface not well suited to metamodel requirements gathering or logical design, or to the review and revision of existing metamodels in a team setting.

In modifying or revising an existing metamodel or creating a new metamodel, it has been found difficult to modify the metamodel in an expeditious and yet interactive way. This poses the problem in iteratively changing an existing model, in the event that the business processes changes. Because of the complexity of the different work processes, the relationships and the underlying of classes that exist within a given model, it is difficult to change an existing model without iteratively communicating between the program developers and those individuals tasked with using and revealing the model that the developers developed.

One tool known as the metamodel requirements capture tool provides the ability to abstractly visualize and demonstrate the features associated with the use of the different classes and objections. From the metamodel requirements capture tool, it is possible to generate one or more spreadsheets that demonstrate in a tabular format, the different software language, the different XML software language, that is necessary to be changed in modifying the underlying metamodel.

The benefit of the spreadsheet is the ability to review the language that is implied in modifying the metamodel to ensure consistency of terminology, consistency within relationships and the difference between the object and the target. This also provides the ability to make sure that the problem with the spreadsheet.

The problem with the spreadsheet, however, is an inability to quickly move between the spreadsheet and the visual display that the metamodel provides. There is, therefore, the need to take the requirements that exist in the demonstrative spreadsheet and create from the spreadsheet the metamodel files. This permits the creation of classes and the relationship types that are used from the metamodel file in the actual metamodel itself.

Thus, in making this transition from the spreadsheet to the metamodel files, well over two hundred relationships arise. As a result, keeping even these relationships that are visible, straight, and consistent becomes a challenging task. Accordingly, there is the need to better manage the translation between the spreadsheets that arise from the metamodel requirements capture process and translating those into metamodel files for use in the metamodel system.

There is the further need for the ability to translate contents of a metamodel requirements capture spreadsheet and turned those metamodel requirements capture spreadsheet contents directly into metamodel files.

There is a need for a method and system for solving the time-intensive problem of populating a modeling environment with metamodel files that enables batch generation of metamodel features.

In the metamodel design, there is the need to review the metamodel components rapidly, enabling timely reviews by the team and the subject matter experts.

There is a need for a method and system that avoids the need to re-enter the specifications for the approximately many relationship types of a metamodel user interface to generate the metamodel XML files directly from the specification spreadsheets.

### SUMMARY OF THE INVENTION

In accordance with the present invention, a method and system for automated metamodel system mark-up language file generation from a plurality of metamodel system requirements is provided that substantially eliminates or reduces the disadvantages and problems associated with prior methods and systems for generating modeling system input files.

According to one aspect of the present invention, there is provided a method and system for automatically generating a plurality of metamodel input files using a set of metamodel requirements derived from a metamodel system. The invention provides the steps of capturing from the metamodel system a set of metamodel requirements. The invention then saves the captured set of metamodel requirements in at least one requirements spreadsheet. Then, the system opens the at least one spreadsheet for making accessible the captured set of metamodel requirements. Next, the invention generates at least one each of an object type mark-up language file, a relationship type mark-up language file, and a symbol file by applying a predetermined set of macros to said at least one requirements spreadsheet. The mark-up language file may be in the form of spreadsheets. The system then generates from the specified object type file, relationship type file, and symbol XML file a plurality of metamodel system input files.

A technical advantage of the present invention is a significant increase in productivity and reduction in the delivery cycle time. Using the present invention significantly reduces errors in the development of metamodel system input. The present invention, moreover, compares, sorts, and analyzes more easily, and then directly translates specifications into executable metamodel files.

Other technical advantages the present invention include both graphical and textual means to gather requirements present and review metamodels. The present invention makes it possible ultimately to generate the metamodel files that will be used to create the models with significantly improved productivity, quality, and repeat-ability. Using the metamodel generator process and system of the present invention, the metamodel specification spreadsheet is processed automatically in a batch mode, without requiring re-entry of specifications.

Still another technical advantage of the present invention is avoiding the need to manually re-enter mete model file requirement using a graphical user interface. The present invention allows the user to more carefully and completely specify the metamodel requirements. The present invention also enables review of metamodel object types and relationship types as a set, which is very useful in reviewing and editing the resulting metamodel. The present invention, therefore, avoids the need to edit the metamodel markup language files directly in a text editor, which is an even more tedious and error-prone process.

The present invention also takes advantage of the fact that the metamodel files are typically markup language or XML files. The present invention provides the ability to use a graphical user interface to create an object type and take the different object types that are needed by a metamodel and form inputs for metamodel files. The present-invention also allows this to occur directly from the metamodel requirements capture spreadsheets. Thus, for example, for the object class, the relationship class, and the target class of objects, the present invention provides an automated way to generate metamodel files.

Other technical advantages are readily apparent to one skilled in the art from the following FIGUREs, description, and claims.

### BRIEF DESCRIPTION OF THE DRAWINGS

For a more complete understanding of the present invention and advantages thereof, reference is now made to the following description which is to be taken in conjunction with the accompanying drawings and in which like reference numbers indicate like features and further wherein:

FIG. 1 illustrates a computing system that may employ the teachings of the present invention;

FIG. 2 shows a graphical user interface for a metamodel system which may employ the teachings of the present invention;

FIG. 3 presents a process flow for generating metamodel files employing the present invention;

FIG. 4 depicts in further detail the use of the automated metamodel file generating system of the present invention;

FIG. 5 shows a flow for one embodiment of the present invention in automatically generating metamodel system files from a predetermined metamodel requirements capture spreadsheet;

FIG. 6 illustrates the object, relationship, target associations used within the metamodel environment of the present invention;

FIG. 7 provides an operational flowchart of the object metamodel process of the present invention;

FIG. 8 provides an operational flowchart of the relationship metamodel interdigitation process of the present invention;

FIGS. 9 through 13B present exemplary spreadsheets for use in the object metamodel file generating process of the present invention; and

FIGS. 14A through 16B present exemplary spreadsheets for use in the relationship metamodel file generating process of the present invention.

### DETAILED DESCRIPTION OF PREFERRED EMBODIMENT

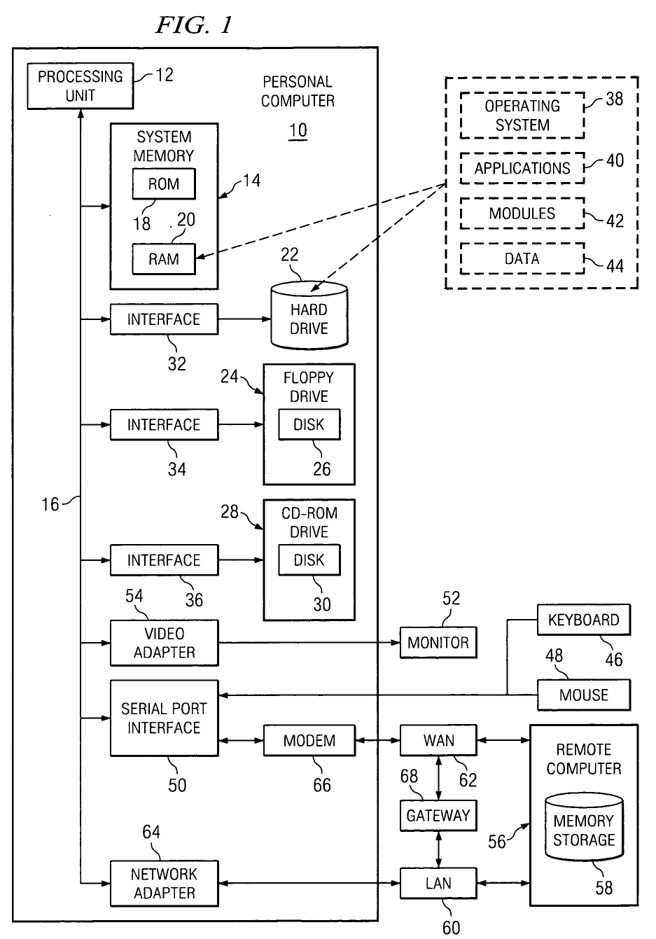

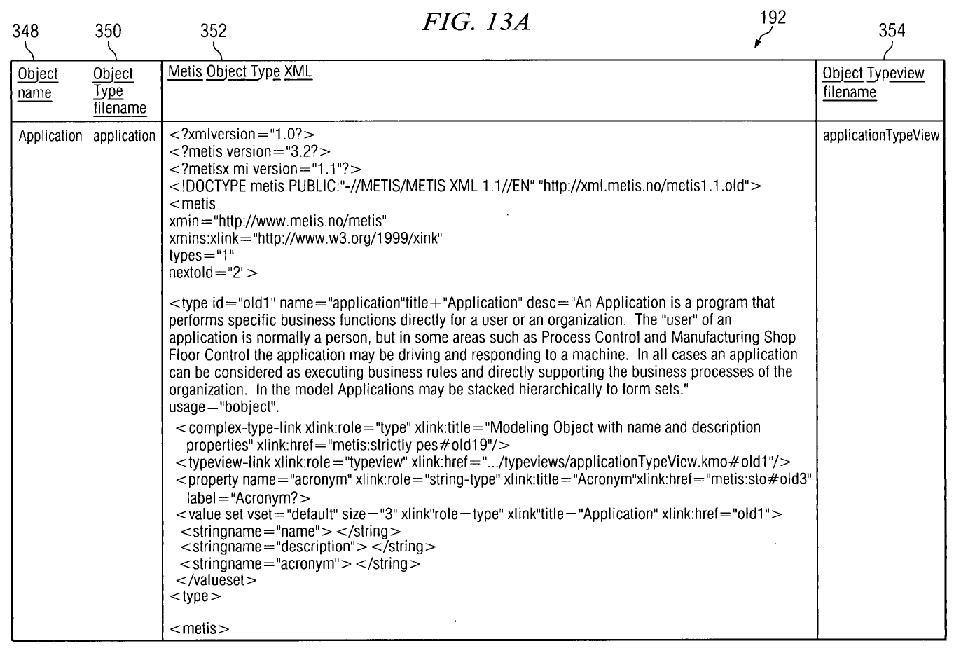

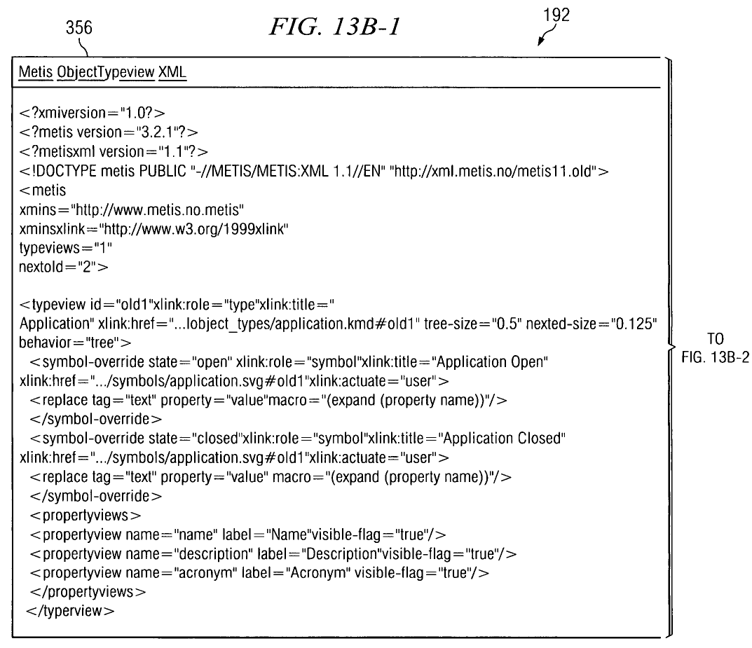

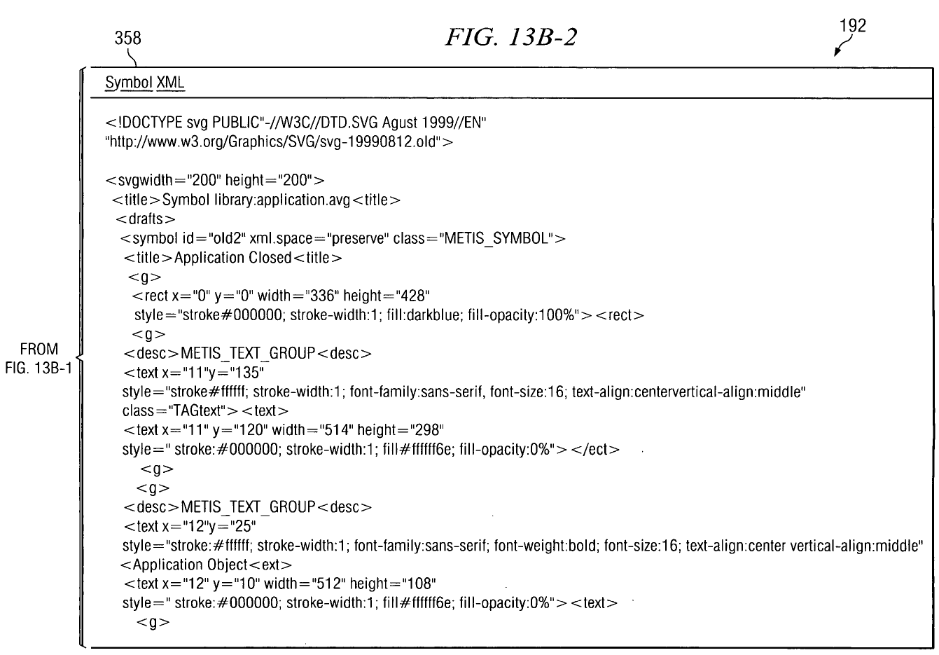

The preferred embodiment of the present invention and its advantages are best understood by referring to FIGS. 1 through 16B of the drawings, like numerals being used for like and corresponding parts of the various drawings.

FIG. 1 illustrates a general-purpose computer 10 that may use the automated metamodel system file generation method and system of the present invention. General purpose computer 10 may be used as a stand-alone computer or as part of a larger, networked system of personal computers. Using at least two such computers, for example, the present invention makes possible metamodel system files at different locations within a given enterprise. Here, FIG. 1 provides an understanding of how one might use the system of the present invention. General-purpose computer 10 may be used to execute distributed applications and/or distributed and individually operating system services through an operating system.

With reference to FIG. 1, an exemplary system for implementing the invention includes a conventional computer 10 (such as personal computers, laptops, palmtops, set tops, servers, mainframes, and other variety computers), including a processing unit 12, system memory 14, and system bus 16 that couples various system components including system memory 14 to the processing unit 12. Processing unit 12 may be any of various commercially available processors, including Intel x86, Pentium and compatible microprocessors from Intel and others, including Cyrix, AMD and Nexgen; Alpha from Digital; MIPS from MIPS Technology, NEC, IDT, Siemens, and others; and the PowerPC from IBM and Motorola. Dual microprocessors and other multi-processor architectures also can be used as the processing unit 12.

System bus 16 may be any of several types of bus structure including a memory bus or memory controller, a peripheral bus, and a local bus using any of a variety of conventional bus architectures such as PCI, VESA, AGP, Microchannel, ISA and EISA, to name a few. System memory 14 includes read only memory (ROM) 18 and random access memory (RAM) 20. A basic input/output system (BIOS), containing the basic routines that help to transfer information between elements within the computer 10, such as during start-up, is stored in ROM 18.

Computer 10 further includes a hard disk drive 22, a floppy drive 24, e.g., to read from or write to a removable disk 26, and CD-ROM drive 28, e.g., for reading a CD-ROM disk 30 or to read from or write to other optical media. The hard disk drive 22, floppy drive 24, and CD-ROM drive 28 are connected to the system bus 16 by a hard disk drive interface 32, a floppy drive interface 34, and an optical drive interface 36, respectively. The drives and their associated computer-readable media provide nonvolatile storage of data, data structures, computer-executable instructions, etc. for computer 10. Although the description of computer-readable media provided above refers to a hard disk, a removable floppy and a CD, it should be appreciated by those skilled in the art that other types of media which are readable by a computer, such as magnetic cassettes, flash memory cards, digital video disks, Bernoulli cartridges, and the like, may also be used in the exemplary operating environment.

A number of program modules may be stored in the drives and RAM 20, including an operating system 38, one or more application programs 40, other program modules 42, and program data 44. A user may enter commands and information into the computer 10 through a keyboard 46 and pointing device, such as mouse 48. Other input devices (not shown) may include a microphone, joystick, game pad, satellite dish, scanner, or the like. These and other input devices are often connected to the processing unit 12 through a serial port interface 50 that is coupled to the system bus, but may be connected by other interfaces, such as a parallel port, game port or a universal serial bus (USB). A monitor 52 or other type of display device is also connected to the system bus 16 via an interface, such as a video adapter 54. In addition to the monitor, computers typically include other peripheral output devices (not shown), such as speakers and printers.

Computer 10 may operate in a networked environment using logical connections to one or more remote computers, such as a remote computer 56. Remote computer 56 may be a server, a router, a peer device or other common network node, and typically includes many or all of the elements described relative to the computer 10, although only a memory storage device 58 has been illustrated in FIG. 1. The logical connections depicted in FIG. 1 include a local area network (LAN) 60 and a wide area network (WAN) 62. Such networking environments are commonplace in offices, enterprise-wide computer networks, intranets and the Internet.

When used in a LAN networking environment, the computer 10 is connected to the LAN 60 through a network interface or adapter 64. When used in a WAN networking environment, computer 10 typically includes a modem 66 or other means for establishing communications (e.g., via the LAN 60 and a gateway or proxy server) over the wide area network 62, such as the Internet. Modem 66, which may be internal or external, is connected to the system bus 16 via the serial port interface 50. In a networked environment, program modules depicted relative to the computer 10, or portions thereof, may be stored in the remote memory storage device 58.

It will be appreciated that the network connections shown are exemplary and other means of establishing a communications link between the computers may be used. FIG. 1 only provides one example of a computer that may be used with the invention. The invention may be used in computers other than general-purpose computers, as well as on general-purpose computers without conventional operating systems.

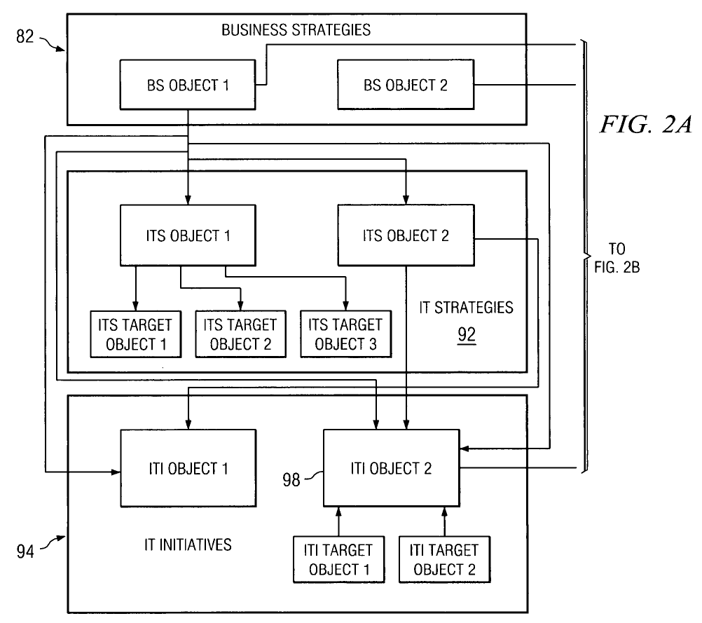

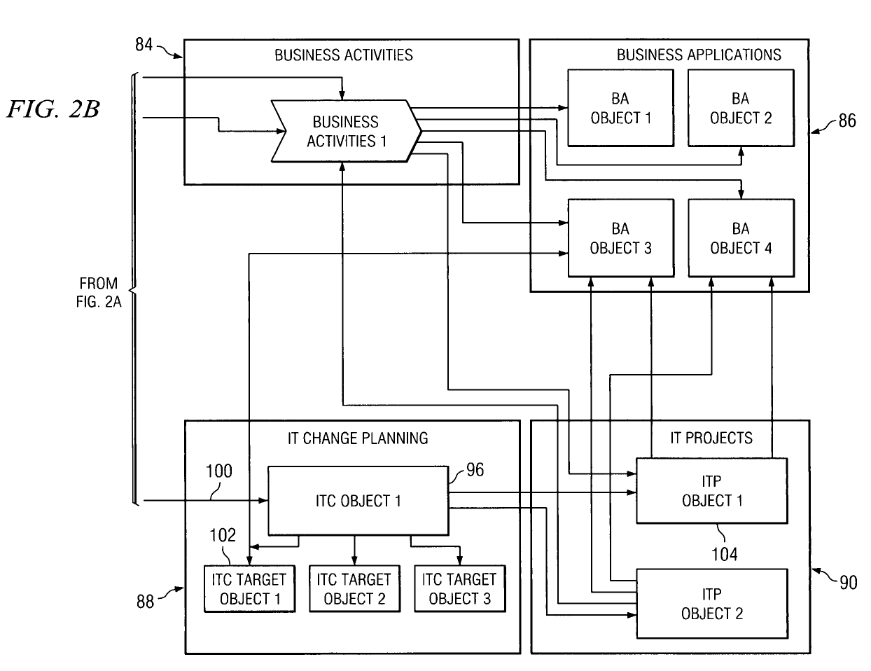

FIG. 2 shows metamodel graphical user interface 80 for which the present invention provides an automated method and system for generating metamodel system files. Although metamodel graphical user interface 80 illustrates a specific example of a metamodel, it also usefully depicts general relationships and objects appearing in the various components of an enterprise metamodel. These, for instance, may include business strategies component 82, business activities component 84, business applications component 86, IT change planning component 88, IT projects component 90, IT strategies component 92, and IT initiatives component 94.

Within each component, such as IT change planning component 88 appear visualizations of objects, such as change plan object 96. Change plan object 96 associates with IT initiatives object 98, as relationship object or connector 100 depicts. Change plan object 96 may also associate with certain IT change planning sub-objects 102 for different functions, such as in this instance, IT change planning. Outputs from change plan object 96 may further pass to IT projects object 104 within IT projects component 92. Thus, with metamodel graphical user interface 80, the user may create a visualization of a functional metamodel of an enterprise.

A model is a useful representation of some subject. It is an abstraction of a reality expressed in terms of some language defined by modeling constructs for the purpose of the user. Models have semantic interpretations that are consistent and inherently understood. A metamodel is a definition or collection of definitions for using objects and relationships in a model. Specifically, a metamodel defines object types, relationship types, methods that can be performed on particular object types, as well as criteria that can be used to search a model. Metamodel information related to a particular area of knowledge is grouped into domains. Every template and model includes references to specific domains to designate which object types, relationship types, methods, and search criteria can be used in a model.

An enterprise model is a method to help determine the total impact of a requested initiative on an enterprise. It provides the structure and repeatable processes to obtain facts and data for an organization leadership to make informed decisions that support its vision. The enterprise model may include of components such as enterprise operations framework; an investment strategy; an integration roadmap and governance. The enterprise model models an enterprise system, which is any integrated solution for linking business processes, data and applications across functions, geographies and business units within an enterprise. The enterprise operations framework provides a complete systems view of how an organization operates today and in the future to achieve its vision of becoming the global leader in the digital economy. It is the foundation for the overall systems design and operation, and represents how an organization will operate, verifies the systems current operational state, and indicates where and how current initiatives are changing the systems base. The enterprises operation framework provides the structure and repeatable methods to employ other components of the enterprise model, such as the investment strategy, the integration roadmap or the governance.

A metamodel system is designed to accommodate the diverse needs in large corporations. The structure of the metamodel system includes a system editor module, which allows the user to build and maintain models. The system designer module includes additional features for setting up and defining model structures. It also comes with a symbol editor, allowing changes in the visual appearance of model elements. The metamodel developer makes possible customizing metamodels, and developing support for new standards and frameworks. When publishing models on an Intranet (or on the Internet), a met-model browser may give the user the full visual power of metamodel in read-only mode. The metamodel may also include a system annotator which can be regarded as a browser with the added capability of creating annotations or comments on objects in existing models. These annotations become visible to the owner of the model, who may then review them. Common features for the different system modules include the properties of them all being stored as XML-files with designer/editor functions scriptable over COM-interface. Graphics for such a model are SVG (Scalable Vector Graphics) and the module designer may include a built-in editor and import function. Custom queries in such a system may be easily pre-defined and run from action-buttons.

A metamodel system is a collection of object types, relationship types, methods, and search criteria related to a particular area of knowledge. For example, a metamodel may include templates for an organization and its resources as they may be used in the operation of an enterprise. Whereas, a model includes groups of related objects and relationships that represent information about an enterprise. Models permit analyzing complex systems, to help answer business questions, and to solve business problems and consists of one or more model views that are used to organize and display information in a meaningful way.

A view includes a graphical representation of objects and relationships in a model. A metamodel system may provide, for example, three types of views, such as model view, object view, and relationship view. The object and relationship views are shown in model views.

The label property is the name of any property for an object or relationship type that can be displayed on a tool tip and is usually displayed on the symbol. For example, the label property for the organization object type is Name. The property label for each type is defined in the metamodel. The value of this property is displayed on the object's symbol and can also be displayed on a tool tip. A property label for each type is displayed in bold on the Instance tab of their corresponding Properties dialog box.

A useful metamodel system provides a visual modeling tool allowing a user to understand increasingly complex enterprises. This enables decision makers and those that carry out the everyday work to share a common understanding, all represented as a visual model. The model forms the basis for making informed decisions, since it becomes possible to reveal the complex interplay within the enterprise.

A metamodel data file can contain model data, for example, objects and relationships. A metamodeling system may receive new files and relocate objects between model data files. In a metamodel system, a type label is the name of the object or relationship type that is displayed for the user, for example, Organization. A component of a model is an object, which represents a specific piece of information about an enterprise (for example, a process, sub-process, process input, process output, or document). An object is created from an object type and values are set for the properties defined in that type. An object is referenced through its Uniform Resource Identifier (URI). Objects are graphically represented on the screen through object views.

The object type characterizes a specific type of information that can be modeled. For example, a metamodel may define the object type Organization, which can be used to represent the parts of an organizational structure within an enterprise. The object type characterizes the properties that an object can have, such as name and description or the default symbol used to represent the object on screen. A model tree could list all the object types available for use in the current model. Object view would provide the visual representation of an object on the screen, by defining the symbol, location, and zoom level used to display the object.

An object may have more than one object view; an object view may be in one or more model views. The View tree lists all object views in the current model view.

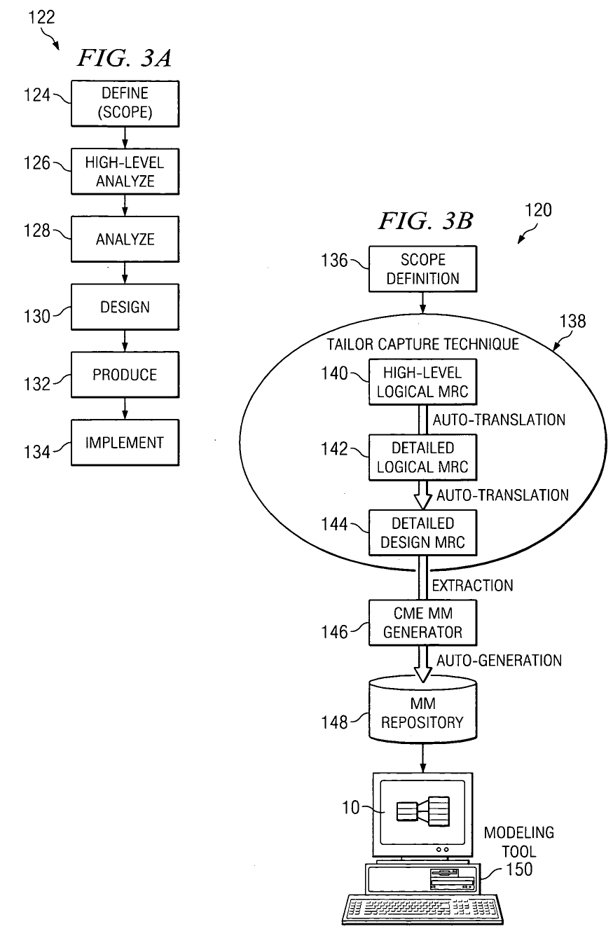

FIG. 3 presents a process flow for generating metamodel files which may use the present invention. FIG. 3 depicts a metamodel development lifecycle flow diagram 120 for one approach for in developing a metamodel using a preferred metamodel requirements capture process with a systems life cycle process 122. Within systems life cycle process 122, the metamodel generator takes the output of design and produces metamodel file repository 148, ready for implementation by metamodel modeling system 150, as herein described. Such a process begins with define step 124, which permits the next high-level analysis step 126 for high level analysis. Analyze step 128 next occurs in systems life cycle process 122, which leads to design step or phase 130. Thereafter, the user can produce, at produce step 132, the desired system for subsequent implementation at implementation step 134.

Mapping to the systems life cycle 122, metamodel development lifecycle 120 begins at scope definition step 136, which may lead to the use of the metamodel requirements capture process 138. Metamodel requirements capture process 138 includes high-level logical metamodel requirements capture step 140, which an auto-translation process leads to step 142 for detailed logical metamodel requirements capture. Detailed logical metamodel requirements step 142 leads to detailed design metamodel requirements capture step 144. Extraction from detailed design metamodel requirements capture step 144 uses the metamodel file generator process 146 of the present invention. The metamodel generator step of the present invention causes the formation of a metamodel file repository 148, which a metamodel modeling system 150 may use within computer 10.

The present invention provides the ability to use a Visual Basic macro, for example, for the purpose of taking the requirements appearing on the metamodel requirements capture spreadsheet and turning those into metamodel files. These metamodel files are then useful for the metamodel system. This can be used for the different model types and relationships. This makes the files ready to use by the ultimate metamodel system itself. By using the metamodel requirements capture spreadsheet, it is possible to translate from the abstract URI into the spreadsheet form. From the spreadsheet, it is possible to generate the metamodel files that are ready for use in the ultimate metamodel system itself.

The present invention provides the ability to create metamodel files that uses windows Excel® macros following on pre-existing Excel® spreadsheets that have been formed through the metamodel requirements capture mechanism. The files that are formed from the use of the visual basic formation of metamodel file are completely compatible with the metamodel file. This creates a way to dynamically create the metamodel files. These metamodel files have the ability to be used within the metamodel system. This allows for the formation of a dynamic interaction between the visualization of metamodel system and the requirements extracted through the metamodel requirements capture facility. As a result of the present invention, there is the ability to dynamically change, modify, correct, and delete aspects of the visual metamodel system. As a result, rapid prototyping of metamodel system is enabled through the present invention.

The present invention eliminates the problems of having to manually type in the information into the metamodel files or into the spreadsheets arising through the metamodel requirements to capture process. The present invention not only avoids the errors associated with this process but also eliminates essentially all time necessary for manually keying in such information. By virtue of being able to see the metamodel in spreadsheet form, the user is capable of seeing relationships that he would otherwise not be able to see. For example, the cardinality of a particular relationship or position is enabled by the structure of the present invention. By being able to see this information, the user is able to employ this information and then take that information and then use it to go directly into the metamodel file but without any type of manual intervention. This allows the user to go directly into the metamodel system via the metamodel files and be able to demonstrate the visual representation of the relationships that are apparent through the spreadsheet that the metamodel requirements capture process generates.

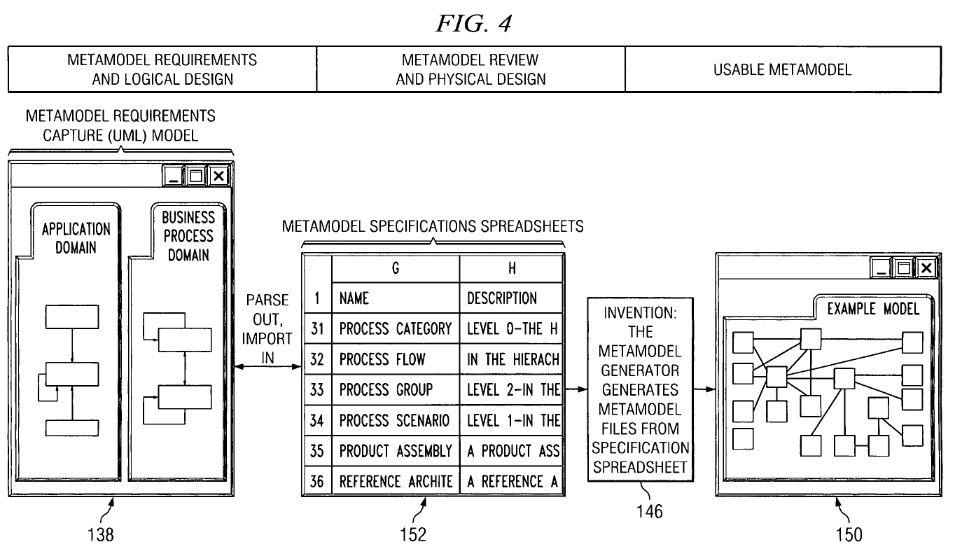

FIG. 4 provides in further detail a process flow for the implementation of metamodel generator process 146 of the present invention. Metamodel requirements capture model 138 parses out requirements from the metamodel development life cycle process 120, which requirements are imported into spreadsheets 152. Metamodel requirements capture model 138 provides a model depicting metamodel requirements, which include specifications for object types and relationship types. Metamodel specifications spreadsheets 152 place metamodel requirements in tabular form and include specifications for object types and relationship types. The metamodel file generator process 146 of the present invention generates metamodel files from specification spreadsheets. Metamodel 150 uses the resulting metamodel files, including object type files, relationship type files, and symbol XML files, from metamodel file generator process 146 for modeling systems, such as an enterprise system.

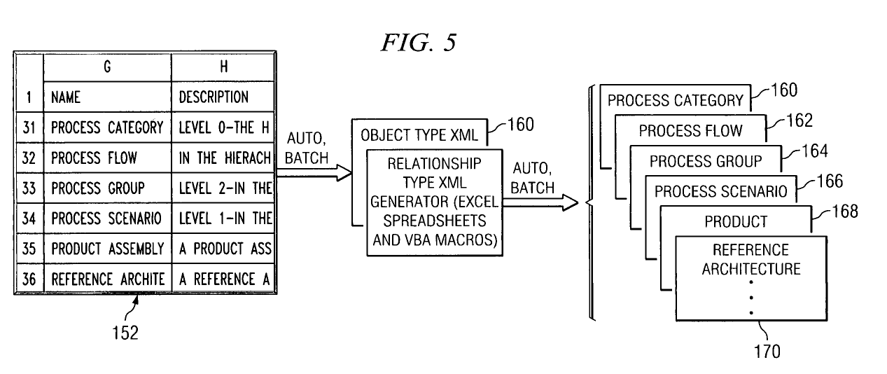

FIG. 5 shows a flow for one embodiment of the present invention in automatically generating metamodel files from a predetermined metamodel requirements capture spreadsheet. FIG. 5 shows in yet further detail the metamodel generator process 146 for taking the captured metamodel requirements from metamodel specifications spreadsheet 152 for generating, through an automated batch process metamodel repository 148 files include, for example, object type XML file 154, and relationship type XML file 156. Metamodel generator process 146 opens metamodel specifications spreadsheets 152, runs a predetermined and herein described set of spreadsheet macro-programs to automatically batch generate all needed object type, relationship type, and symbol type XML files for the operation of processes within metamodel system 150. These processes and objects may include, for example, process category object 160, process flow object 162, process group object 164, process scenario object 166, product object 168, and reference architecture object 170.

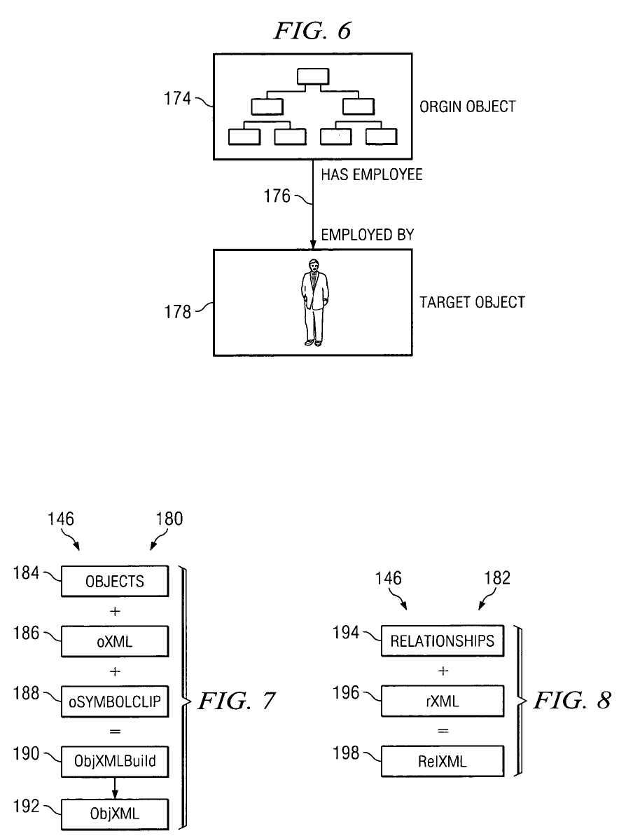

These files enable the key metamodel operation of relating origin object 174 using relationship object 176 to target object 176, as FIG. 6 depicts. FIG. 6, therefore, illustrates the object, relationship, target associates used within the metamodel environment of the present invention.

In a metamodel system, origin object 174 would provide the starting point in relationship 176, relationship 176, pointing from origin object 174 to target object 178. A property is a characteristic for elements such as objects, relationships, symbols, and model views. Properties for an object may include name, description, and date of birth. A relationship connects objects in a model (for example, represents linkages and dependencies among various aspects of an enterprise) and can exist between objects in a container and across containers, but not between model views. Relationships are constrained to the objects they can connect. For example, the relationship has employee Person may exist only between the Organization and Person object types.

In a metamodel, relationship 176 may be visually represented on the screen by a relationship view. The relationship view defines the relationship symbol and zoom level used to display relationship 176. When a new object view is created, a relationship view is also created for each relationship connected to the original object. A symbol is a graphical representation of an object or relationship in a model. Different symbols can be used to represent objects in a model (for example, to visually enhance a model, to represent different states, or to make objects more intuitive for a particular audience). A target is the end object in a relationship. The relationship points from the origin object to the target object.

FIGS. 7 and 8 provide an overview of the metamodel file generation process 146 of the present invention, which includes objects XML file generation process 180 of FIG. 7 and relationship objects XML file generation process 182 of FIG. 8. Objects XML file generation process 180 begins with an Objects spreadsheet 184, an oXML spreadsheet 186, and an oSymbolClip spreadsheet 188. Through a functional interdigitation of these spreadsheets, an ObjXMLBuild spreadsheet 190 results. The process of the present invention further transforms the ObjXMLBuild spreadsheet 190 into ObjXML spreadsheet 192 from which an object XML file 154, as referenced above, may be generated for use by metamodel system 150. Similarly, Relationships spreadsheet 194 combines with rXML spreadsheet 196 to yield RelXML spreadsheet 198, which the process of the present invention uses to produce the desired relationship object XML file.

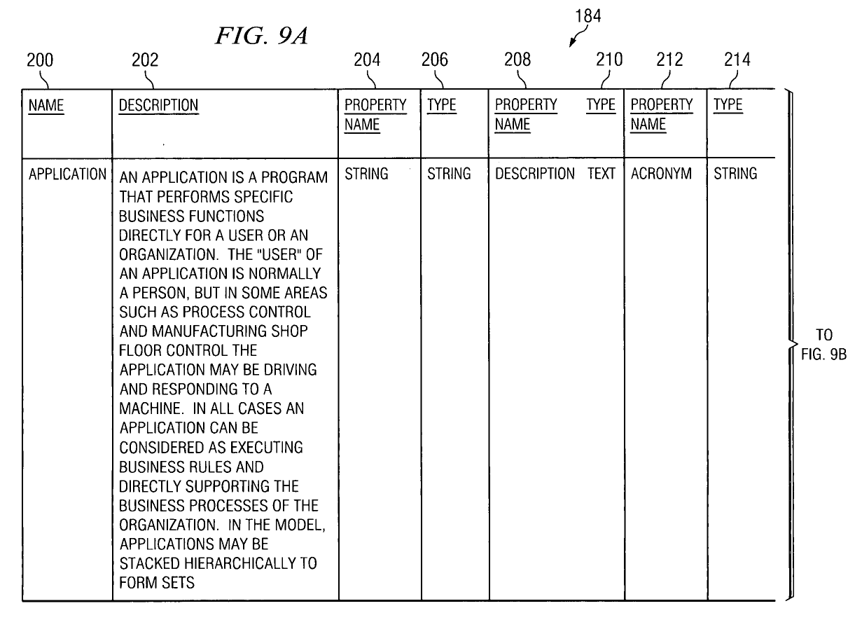

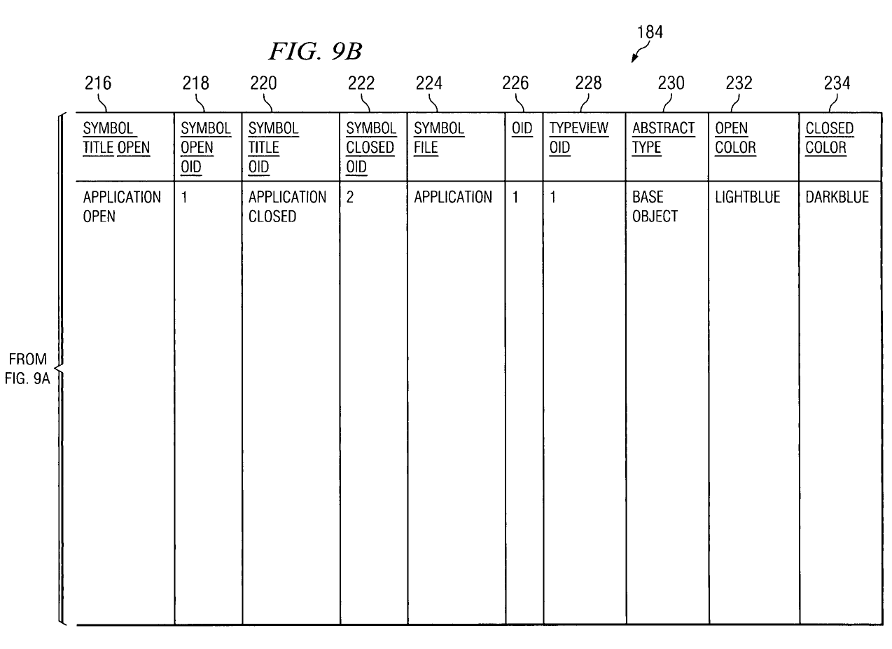

FIGS. 9 through 13B present exemplary spreadsheets for use in the object metamodel file generating process of the present invention. The present invention takes the metamodel requirements capture model and parses it to information for creating the desired XML metamodel file. These are placed in a spreadsheet, which then can be edited and imported into a metamodel XML file. Transformation of data from the spreadsheet into the resulting metamodel files is also provided by the present invention. Accordingly, the present invention provides a three-step process out of which come the ultimate metamodel files.

Objects spreadsheet 184 includes the requirements for a particular object. FIG. 9 column 200, entitled “Name,” which is the name of the object type, followed by the Description column 204, which is the title for the description of the particular object. The next column is the Property Name column 204, which relates to the name of the object. Thereafter, there is information that relates to particular metamodel information that provides the descriptions or indications of particular symbols that are used in the metamodel system.

Columns 204 through 214 repeat the property name and type, which detail the particular properties associated with the object. This is the name of the property, followed by the data type. Thus, Property Name data for column 204 is “Name,” and this is a “String” of data. Then, a second Property Name column 208 is a “Description,” and this is “Text” data, as column 210 shows. Finally, the “Property Name” of column 212 is an “Acronym,” which is a “string” data type as column 214 shows. The Symbol Title Open column 216 refers to the fact that object types in metamodels include data and views of the data. These are separate aspects in the metamodel file. Also an object may be seen in multiple places in the metamodel. The way that an object appears depends on two other files, which are the type view file that associates the object type with a symbol, and the symbol file itself. Thus, every object type has these four files associated with it, including the object type, the type view, the symbol file, and the abstract type. The abstract type for the file identifies the object type, identifies the abstract type to be used in association with a particular object.

An object symbol file contains two different symbols. The metamodel uses one symbol when the object is open. The metamodel uses another symbol when the object is closed. When the user double-clicks on the view of an object in a metamodel interface, the object changes state from open to closed, or from closed to open, depending on the object's existing state. This allows the user to control the screen view and to otherwise modify the appearance of the metamodel in the user interface. Each symbol includes a title.

With the present invention, the symbol title will be the object type followed by the word open for the open symbol or the word closed to associate with the closed symbol. Thus, Symbol Title Open column 216 relates to the symbol title for the open state, while Symbol Title Closed column 220 relates to the symbol title for the closed state. Symbol Open oid column 218 relates to the object identifier.

Each symbol includes an object identifier, which is a number. So, the Application Open object will be given the number 1, as column 218 shows. The symbol closed oid will have the symbol 2, as column 222 shows. Symbol file, column 224 includes the name application itself. This tells the metamodel XML file generation portion of the present invention what is being generated. This will relate to whether there is an entire file or part of the file that is being generated. The oid column 226 includes the oid for the application type itself. The typeview oid column 228 includes the numeral “1” indicating that the oid is “1” for the Application Object. The Abstract type column 230 relates to the abstract type which includes the characteristics that the particular object will inherit. In this instance, the application object is a base object. For the graphical user interface, Objects spreadsheet 184 illustrates the colors that appear in the user interface for when the object is open, here light blue, and when the object is closed at column 234, here dark blue, as they appear on the screen. These words will be used by the metamodel file to generate the appropriate or respective colors on the graphical user interface.

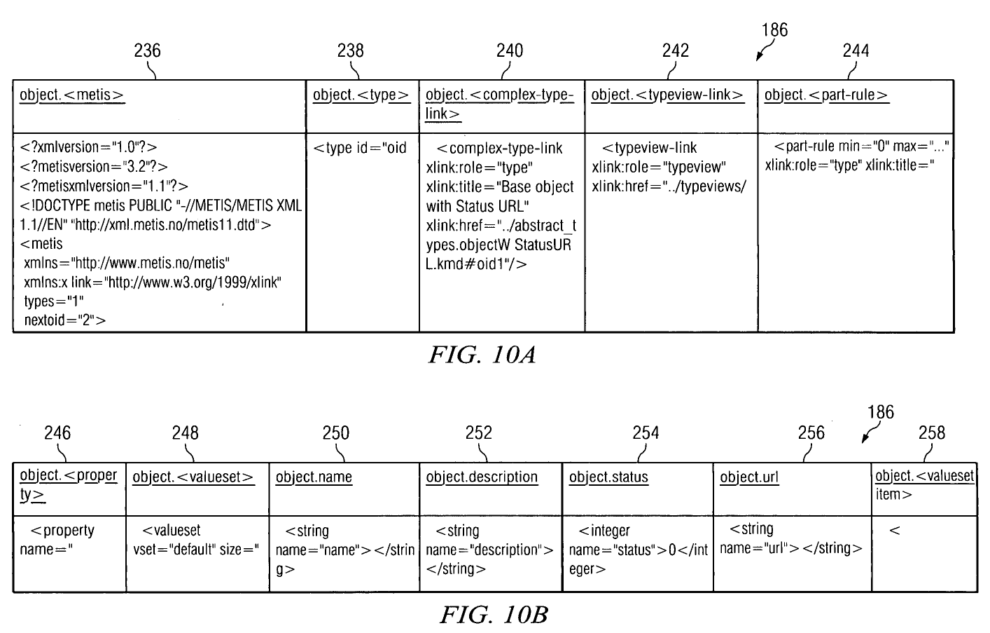

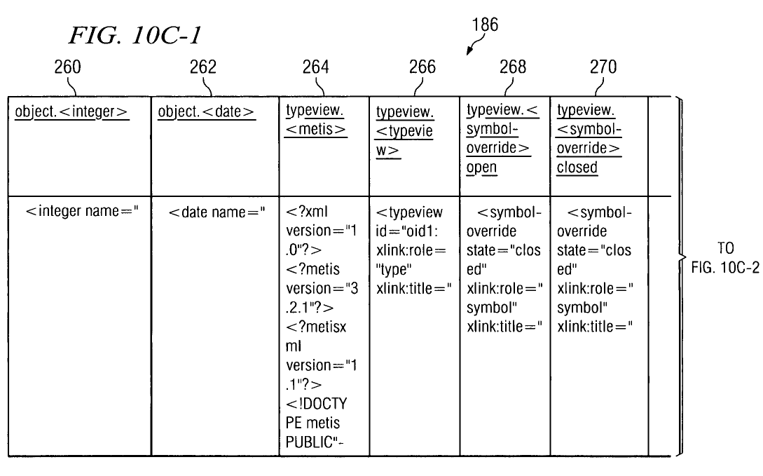

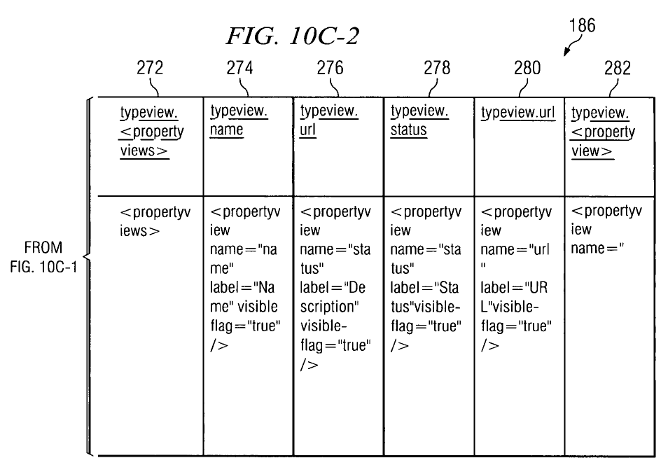

The XML spreadsheet 186 of FIGS. 10A, 10B, and 10C provides the XML code for generating the desired metamodel XML files. This information is generic to object type of the present invention. Thus, with an object type file, for example, are different pieces of software code that the components of the XML spreadsheet 186 provides detailed specifically in the order in which they appear in the XML file. As a result, information to create an object XML file is presented in the respective cells of OXML spreadsheet 186. In OXML spreadsheet 186 object.<metis> establishes the initial header portion of the XML file. The object.<type> 238 provides the declaration of the object type. The object.<complex-type-link> column 240 establishes the inheritance from the abstract type. This establishes the inheritance that the object will obtain from the abstract type. The column object.<type-view-link> column 242 provides the connection between the object type and the typeview file. This uses a folder naming an assignment convention. As object.<part-rule> column 244 establishes the conditions for when the object is hierarchical, such as where there are children or sub-ordinate with the same type as itself. Object.<part-rule> column 244 provides a statement of particular rules for the hierarchical structure.

The next column of oXML spreadsheet, which appears in FIG. 10B is entitled objects.<property> provides the property name for the particular object. Column 248, entitled object.<value set> provides the object value set data. Column 250, entitled object.name stores the string data for a given object, for which object.description column 252, object.status column 254, and object.URI column 256 provide associated context. Object.<value set item> column 258 provides the conclusion, parameter for the object value set. The column 260 appears in FIG. 10C, is entitled object.<integer> and provides the object.integer function, which is an aspect and provides the integer name for the particular object. Column 262 is entitled object.<date> and provides the date name for the particular object. Column 264 typeview.<metis> contains the header data, which appears at the very beginning of the typeview file for the particular object. Column 266, the typeview.<typeview> column provides the beginning declaration of the typeview entity within the typeview file. Column 268, typeview.<symbol-override> open column declares the symbol for the open view state for the particular object. Column 270, entitled typeview.<symbol-override> close provides the statement of the symbol for the closed state of the particular object. Column 270, entitled typeview.<property views>, begins the enumeration of the views of the properties of the particular object, as it will be expressed in the user interface for the model. The typeview.<name> column 274 declares the name of the property in the property view for the particular object. The typeview.<description> column 276 declares the description property for the particular typeview. Column 278, entitled typeview.<status>, provides the status of the particular type view. Column 280, entitled typeview.<URI>, provides the property type view of the associated URI designation. Typeview.<property views> column 282 is distinct from typeview.,<property views> column 246 in the sense that typeview.<property views> column 246 begins the declaration of a set of properties. On the other hand, the typeview.<property views> column 282 is used to generate the first number of the associated set.

The next spreadsheet entitled Object View, the object symbol clip includes the title Symbol XML-Open and -Close. Contents of the Symbol XML spreadsheet, the XML code for an SDG metamodeling system of the present invention, takes the text appearing in the symbol clip spreadsheet and provides the symbols. This is specified in XML according to the SDG standard. The present invention will take the generic text and replace the generic closed text with the information with what the object sheet takes.

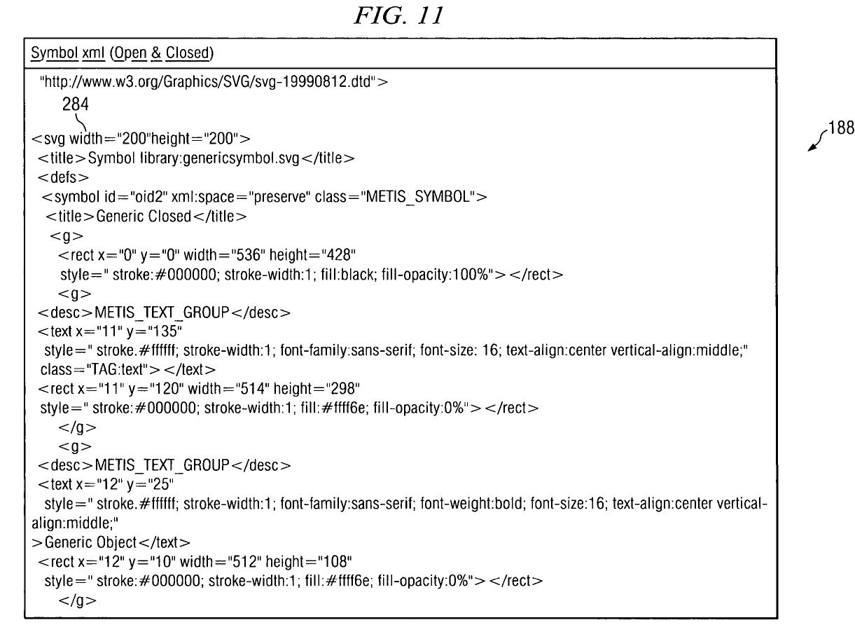

Contents of the Symbol XML sheet provides a similar object, which is a rendering file for providing the particular type of object, the different type of tags that might be used, and other aspects. These three sheets are combined in a functional summing, or interdigitation, in the sense that various pieces are assembled in a particular order. Thus, in Objects spreadsheet 184 appears information about the particular object that is being generated. OXML spreadsheet 186 of FIG. 11 includes the generic XML text XML file for the metamodel system in the sense that the pieces which the particular object are included in the XML spreadsheet. The generic and specific parts are used as appropriate with any object type. oSymbolClip spreadsheet 188 provides the symbol XML text for the symbol XML file of the metamodel system.

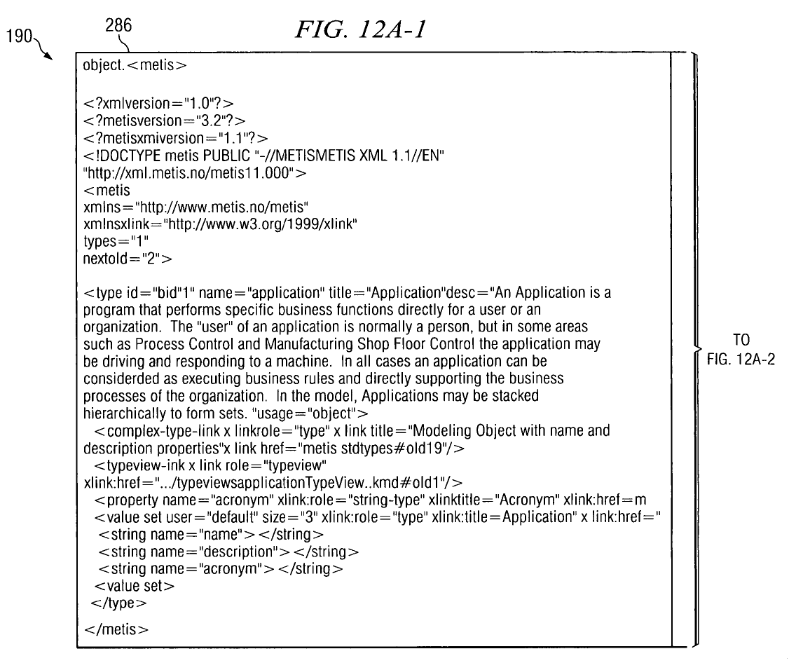

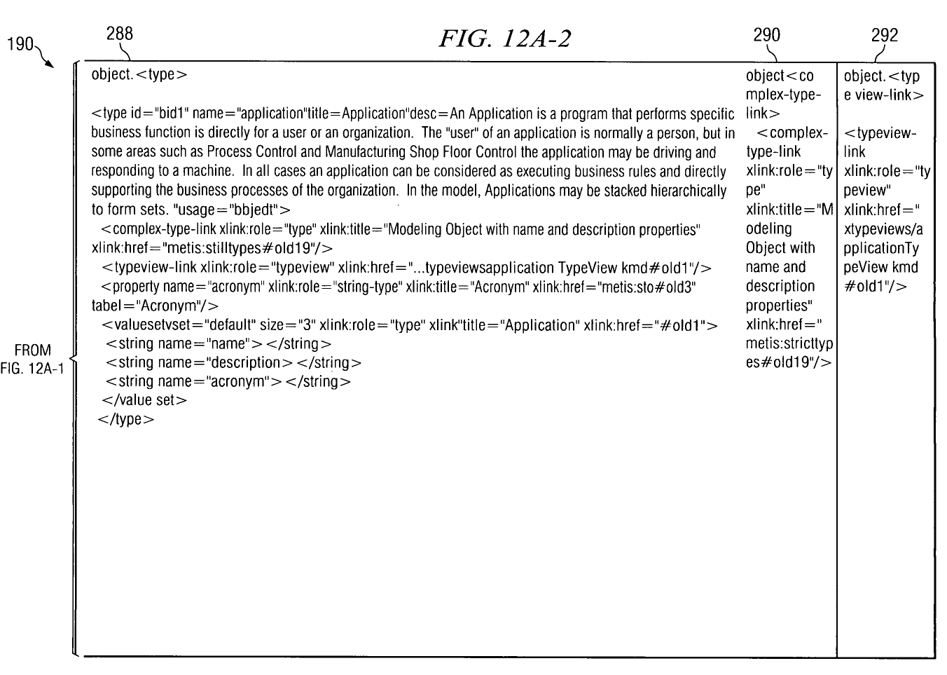

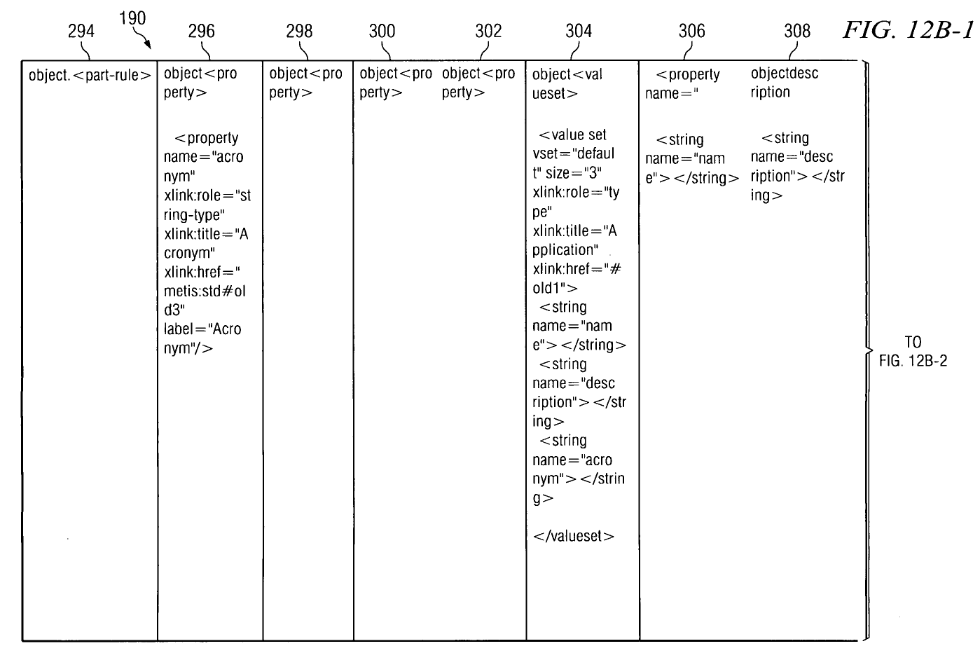

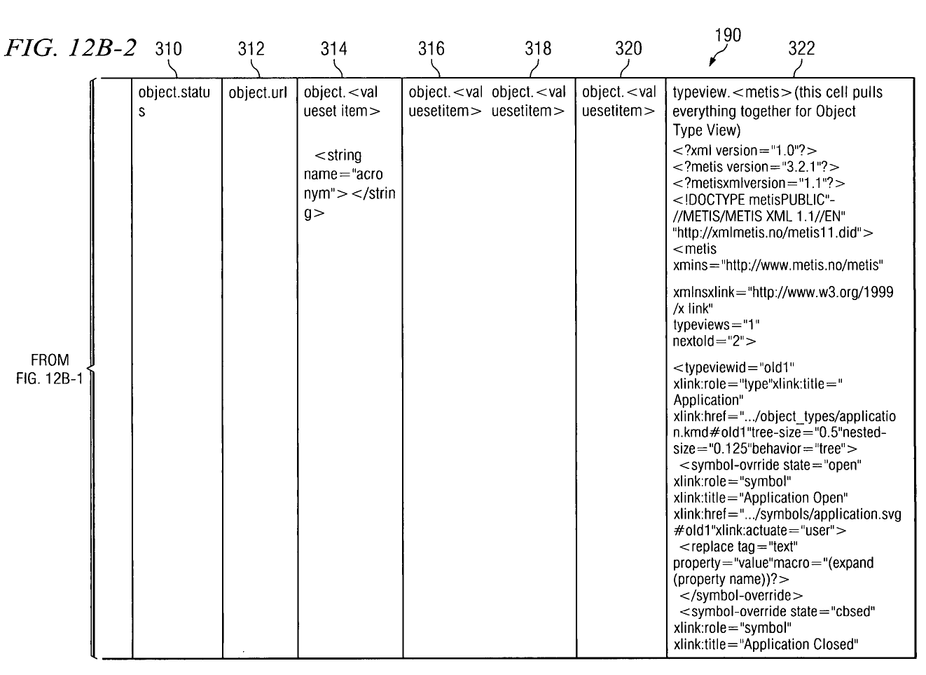

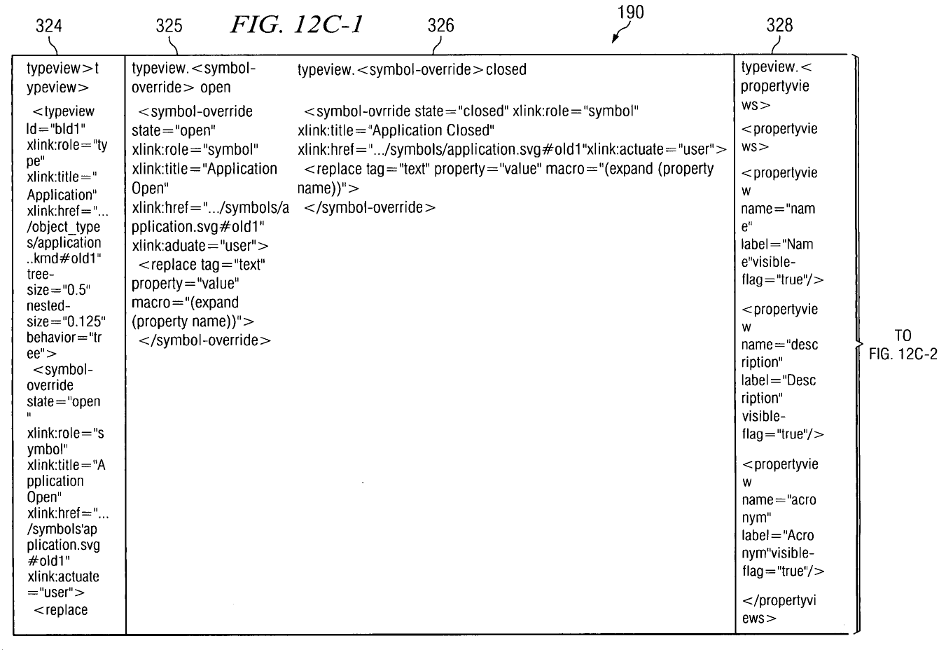

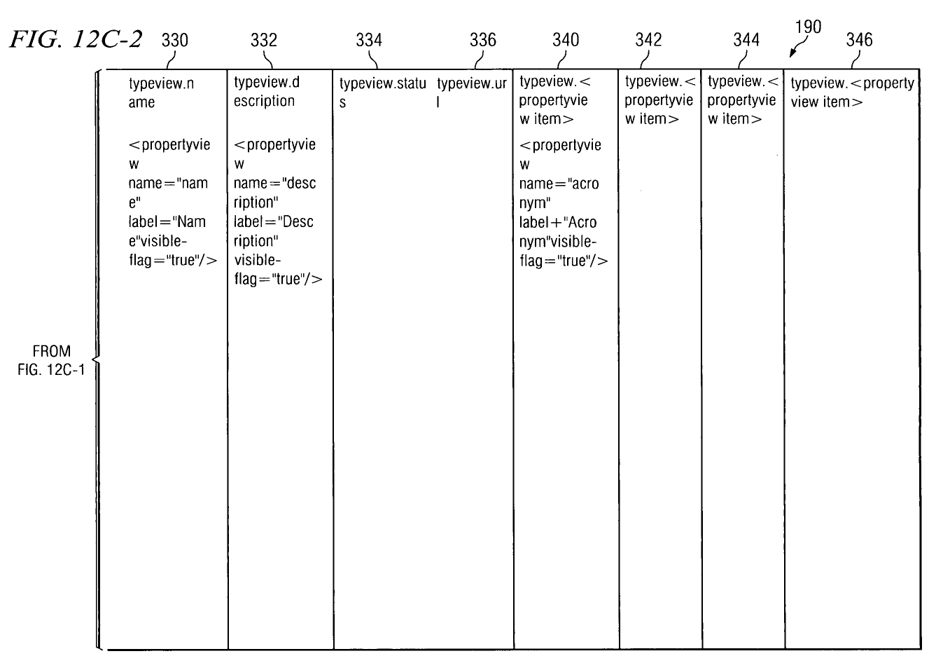

FIGS. 12A, 12B, and 12C show the ObjectXMLBuild spreadsheet 190. The ObjXMLBuild spreadsheet 190 illustrates the process by which the present invention assemble information for use in generating the desired metamodel system XML files. In ObjXMLBuild spreadsheet 190, a row exists for every row in Objects spreadsheet 184. The process of the present invention assembles the different components of a particular row for the different object types. In the event there is a second object type in the object sheet, there is the need for another row in ObjXMLBuild spreadsheet 190. Thus, in understanding ObjectXMLBuild spreadsheet 190, it is appropriate to refer to the left-most column 346, appearing in FIG. 12C, entitled typeview.<property view item>.

The present invention provides for the assembly of portions of XML code. These are formed according to the particular type of XML entities and attributes. Beginning with typeview.<property view item> column 346, essentially four columns 346, 344, 342, and 340, entitled typeview.<property view item> appear, because all objects will have the name of the description property. The next columns, proceeding to the left, are typeview.<URI> column 336, typeview.<status> column 334, typeview.<description> column 332, and typeview.<name> column 330, all of which associate with the typeview.<property views> column 328. Typeview.<description> column 332 and typeview.<name> column 330 provide description and name type views, respectively. This continues, moving to the left, to typeview.<property views> column 328, all of the types views are assembled into a single block of text. In typeview.<symbol-override> closed column 326 is the assembly of all the information needed for the <symbol override>—closed display information. Likewise, in the typeview.<symbol-override>—open column 325 is the assembly of all necessary information for the type view open symbol. Thus, the oid, and symbol name and file names that appear in the objects file are all collected in the respective typeview.<symbol-override> closed column 326 and typeview.<symbol-override>—open column 325. Typeview. <typeview> column 324 includes the typeview information and property views that were provided in Objects spreadsheet 184.

Referring to FIG. 12B, the column typeview.<metis> column 322 appears, which pulls information together information for the object typeview. It should be noted that, although the underlying functions that assemble this information are not here provided, the functions are straightforward and are the combination of references from the Excel® spreadsheet functions that may be provided in the operation of the respective XML spreadsheet. A person of ordinary skill would have the ability to provide the extracted information. Thus, by providing each object with a particular specification and a particular row, the information may be copied from the prior-described spreadsheets for the purpose of generating the information in this cell that appear in ObjXMLBuild spreadsheet 190.

Running a macro that assembles this information populates ObjXMLBuild spreadsheet 190. Thus, understanding what the resulting XML file includes the ability to generate the necessary macros that can be used to populate the cells within the ObjXMLBuild spreadsheet 190. The columns 320, 318 and 316, entitled Object.<value set item> are empty. This is followed, again proceeding to the left by the object of value set column that includes the string name of the particular acronym. The values in the object.<value set item> column 320 are those that are in addition to the specified characteristics or properties that are listed in the adjacent object.<URI> column 312, object.<status> column 310, object.<description> column 302, and object.<name> column 306. The object.<value set> column 304 to the left of the object.<name> column 306 assembles all of the information of the columns to the right, beginning at object.<name> column 306 and concluding with the last, in this instance, empty object.<value set item> column 320. This is the information that goes inside the type entity that goes inside the object XML file of the metamodel system. The following object.<property> columns 302, 300 and 298, in this instance, are empty, however, object.<property> column 296 includes information that relates to the acronym property name. The object.<property> column 296 may also include information that relates to the declaration of the name description properties. The object.<part-rule> column 294 addresses the characteristic of the object type being a hierarchical object and provides the part rule which relates to the object.

Referring to FIG. 12A, there appears object.<type view-link> column 292, which creates the typeview link for linking the typeview file text to the object property column 266 text. The object.<complex-type-link> column 290 provides a link of the abstract type, which is inherited from the object. Next, object.<type> column 288 provides the assembly of the information by taking all the information and collecting it into one spreadsheet cell. Finally, object.<metis> column 286 includes everything that has been created in the columns to the right and collects them in one comprehensive spreadsheet cell, which cell also includes all relevant header and related information for the subsequent assembly.

ObjXML spreadsheet 192 provides the information the metamodel system needs to operate. This includes the content of Object name column 348, Object Type filename column 342, and Metis® object type XML column 352. Object typeview file name column 354 includes the object type views file names. Metis® Object Typeview XML column 356 provides the XML code in use for the object XML file. Symbol XML column 358 provides the information relating to the symbol XML file. Object XML spreadsheet 192, therefore, creates XML text that the metamodel uses to create the view of the XML model in the metamodel user interface. In summary and as applies to the Application object example, this portion of the process of the present invention creates the application typeview file, the Application.KMD. A set of spreadsheet macros then create three files including Application.KMD, Application TypeView.KMD, and Application.SVG. These may be saved into three different folders by the metamodel file.

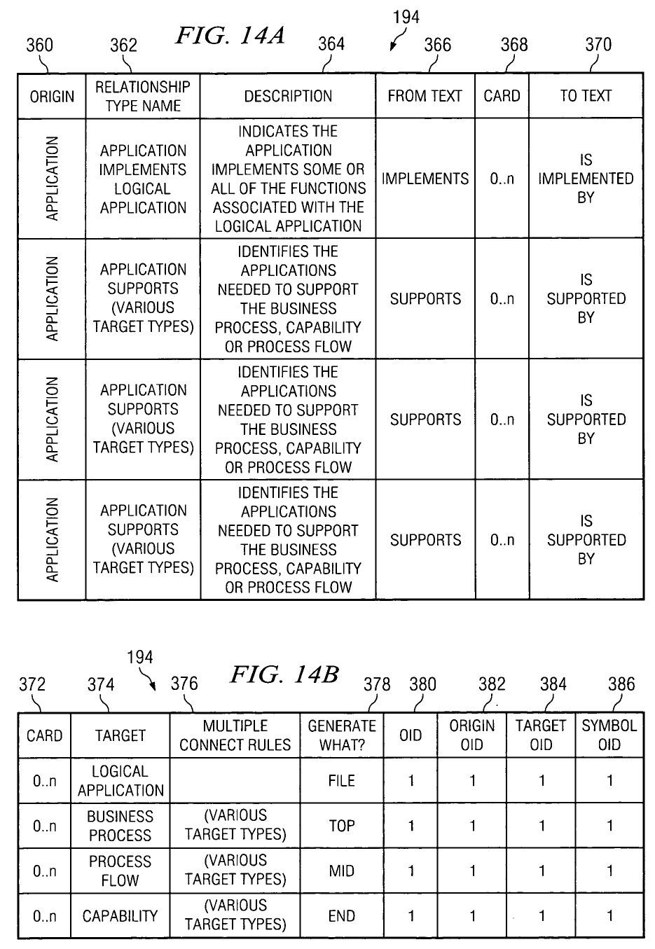

FIGS. 14A through 16B present exemplary spreadsheets for use in the relationship metamodel file generating process of the present invention. In particular, FIGS. 14A and 14B shows relationships spreadsheet 194, including Origin column 360, Relationship Type Name column 362, Description column 364, From Text column 366, Card column 368, To Text column 370, Card column 372, Target column 374, Multiple Connect Rules column 376, generate what? column 378, oid column 380, origin oid column 382, target oid column 384, and symbol oid column 386. Relationship spreadsheet 194 of FIGS. 14A and 14B establishes a relationship between two metamodel objects. Origin column 360 of relationship spreadsheet 194 provides an application origin relationship that connects an origin object with a target object.

Columns 360, 362 and 364 of relationship spreadsheet 194 are pieces of the relationship object. This connects one origin type with three different target types. The approach of the application rows 3, 4 and 5 present a standard that is used within the present invention. Thus, a relationship type can connect a broad array of connection rules. The relationship rules define the way that objects connect to targets within the metamodel system. The present invention, therefore, provides a representation of how one origin type may connect to one or more target types according to the metamodel system relationship rules.

The example in row 2 of relationship spreadsheet 194 provides for one origin and one target to associate through the implements relationship. The origin or object type of column 360 provides the type of object with which the relationship type will always start. Relationship Type Name column 362 includes the name of the origin object type, and then some sort of verb, here implements, and a name for a target object. The Logical Application is the name of the target object. Column 364 includes the description which indicates the complete description of the relationship. Here, the description is “indicates the application implements some or all of the functions associated with the logical application. Column 366 is the From Text column, which allows for the view from the origin type to understand the relationship to the target type. In this instance, the From Text relationship is “implements.” In contrast, the To Text is the view from the target object. Here, the relationship is from the target viewpoint, here “is implemented by.”

The Card columns 368 and 372 indicate the cardinality of the object. The cardinality specifies whether the relationship is optional. It also indicates how many are connected in the relationship. For example, in this example, the first part is “0;” however, the number could be “1.” Ordinarily, the number is “0” or “1.” If the number is 0, this allows for a logical application to exist, similarly, going the other direction, it is optional the other way. Thus, it is possible to have a logical application attached to it. In actuality, each physical application implements a logical application. In the cardinality, the letter “n” represents the number of connections that could connect. Thus, the “n” means that an application can implement any number of logical applications. And a logical application can be implemented by any number of physical applications. This number is ordinarily “n” or “1.”

Target column 374 is similar to the Origin column, but indicates the name of the target object. Thus, columns 360 through 374 indicate the relationship that is being described. Multiple Connect Rules column 376 indicates a relationship that is determined automatically. Thus, if there is a single origin object type followed by the same verb connecting to multiple target types, which is the case here, the relationship type main calculation uses this value to determine what the name should be. Thus, in column 362, it is indicated that “Application supports (various target types),” that is, any number of target types. It is not necessary to enumerate those in the relationship type name. Column 378, entitled “generate what?,” indicates what type of file is being generated or what part of a file is being generated. Thus, in row 2, the term “file” specifies the relationship type, while rows 3, 4 and 5 indicate the generation is portions of a file. The metamodel file generator of the present invention, therefore, will generate not a complete file, but a top part of a file from row 3, a mid-portion of a file from row 4, and an end-portion of a file from row 5.

The present invention, therefore, provides for a spreadsheet macro program to recognize the “Generate What?” column contents to automatically generate the different portions of the file. Furthermore, oid column 380 indicates the identifier of the file, origin oid column 382 provides the origin oid, the target oid column 384 provides the target oid, and symbol oid column 386 indicates the symbol oid. The respective oid's are “1,” here, but with older meta models these numbers may be different.

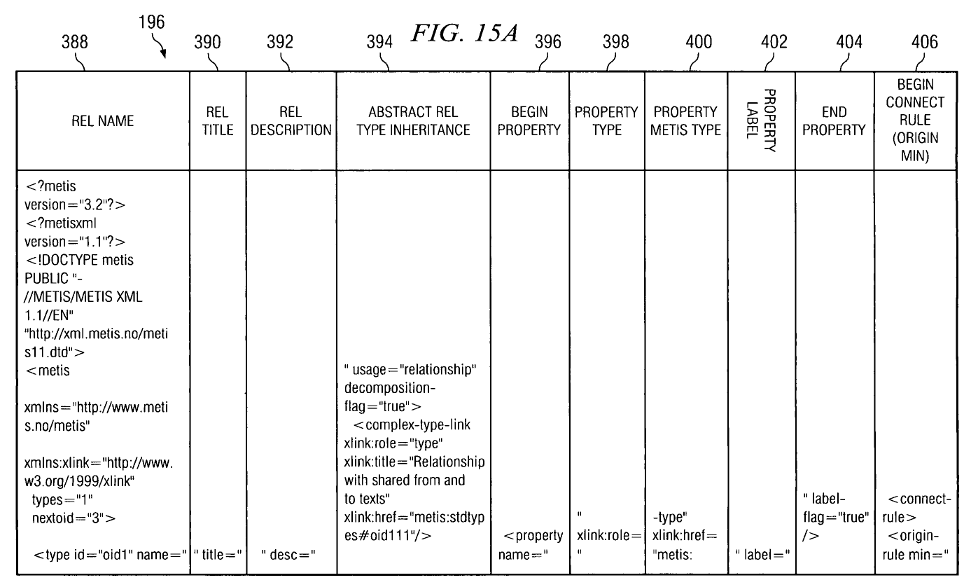

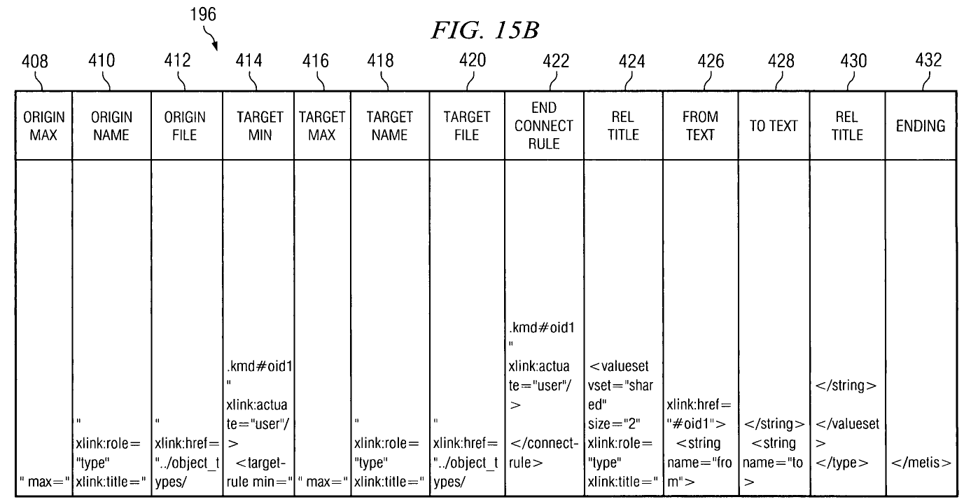

FIGS. 15A and 15B show one example of rXML spreadsheet 196, which provides pieces of XML code that will be interspersed with the specific pieces. Viewing rel name column 388, there appears the relationship content including a generic specification of the content for a particular relationship type. The top of the file begins at the left-hand end of this sheet and proceeds to the right. Thus, the rel title column 390 specifies the title for the relationship. This is the beginning of the type entity in XML. Columns 390 and 392 provide relationship text, including the “title” and the “description” text.

Column 394 entitled “abstract rel type inheritance” explains the distinction between the object instance and the object type view. There is the relationship instance that is a relationship created from the relationship type. There is also the relationship type view that is also created. This allows for the demonstration in multiple views. The content of abstract rel type inheritance column 394 establishes the inheritance property associated with a relationship. Begin property column 396 provides the information beginning with the property name. Property type column 398, property notice type column 400, property label column 402, and end property column 404 are the main properties with names or relationships with a given property. In many examples, however, these columns may not be used. Column 406, entitled “begin connect rule origin mix” defines the origin object type.

For each pair of origin and target view, there is the iteration of a connect rule. So in the first relationship would be one connect rule. The second relationship would include three connect rules. The information provided in column 406 continues through column 408, which gives the origin maximum cardinality. Column 410 gives the origin name, Column 412 gives the origin file, which is the file name. Column 414 gives the information for the minimum and maximum, which includes column 416 of a particular topic. Column 418 gives the target type name for the object, while column 420 gives the target file. Then, column 422 gives the end connect rule for the object. Columns 424 through 430 give the “from” and the “to” text for a given relationship period. This shows how the relationship may be displayed in the model. Column 432, entitled “ending,” provides a symbol in letters for the ending of the relationship.

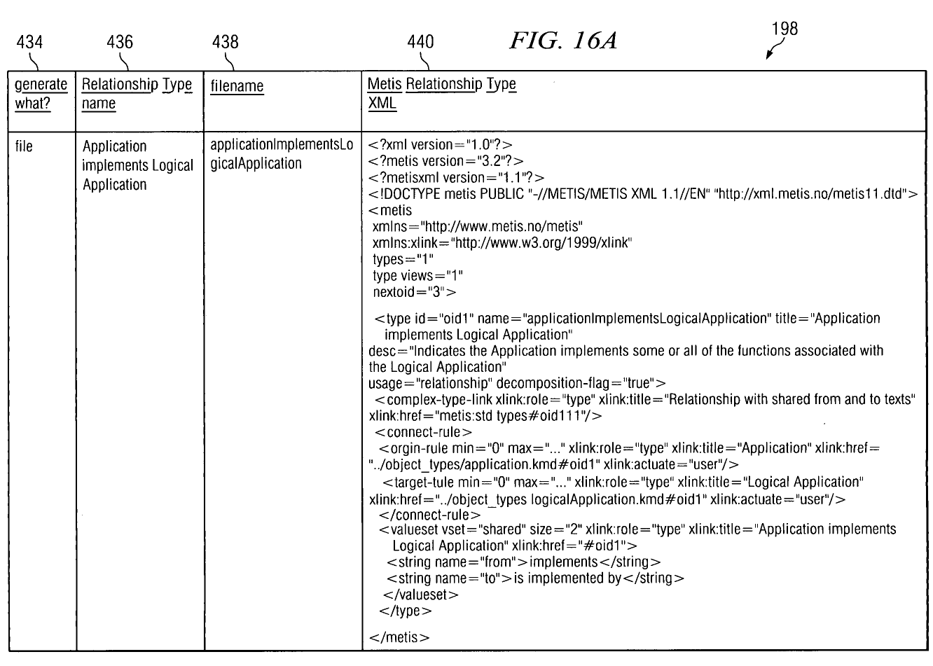

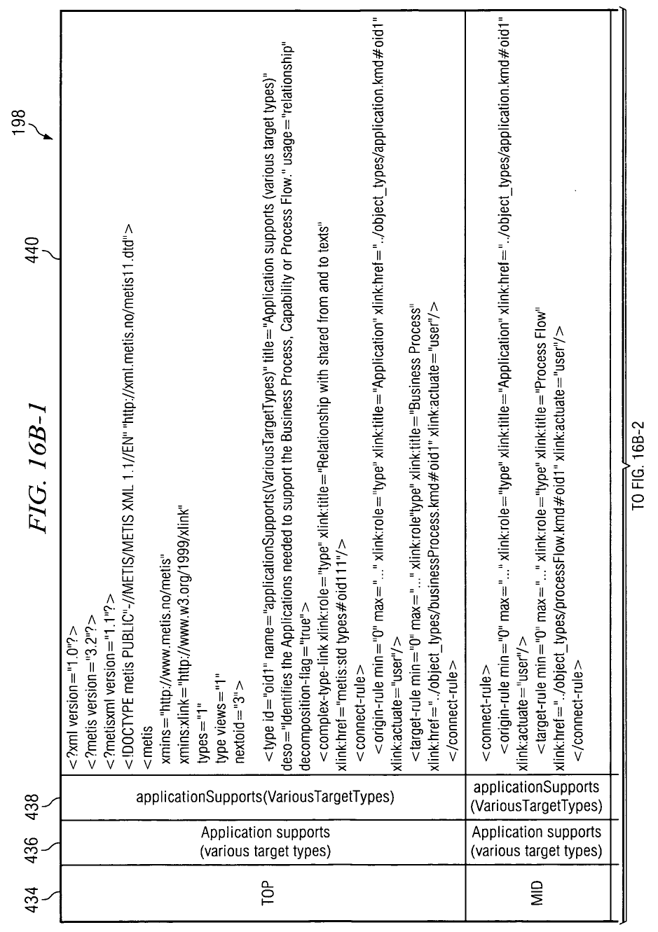

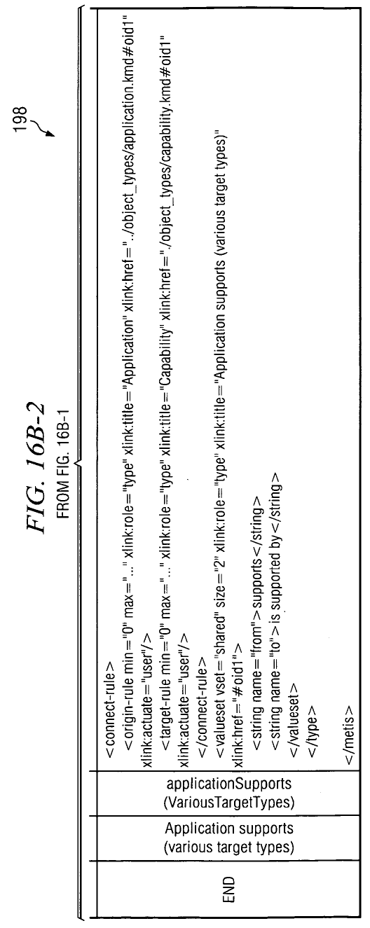

The RelXML spreadsheet 198 of FIGS. 16A and 16B includes information from which the present invention may created a metamodel XML file automatically for use in a metamodel system. Generate what? column 434 is a transformation of the logical name of the relationship type. This convention is followed with the object types as well. Column 436 indicates the relationship type name here, application implement logical application. Furthermore, column 438 indicates the file name which according to the present invention is a logical combination of the relationship type and name. Here, the name “Application Implements Logic Application” provides a logical descriptor for the relationship type name. Column 440 provides the combination through interdigitation of Relationship spreadsheet 194 of FIGS. 14A and 14B and rRXML spreadsheet 196 of FIGS. 15A and 15B. Thus, column 440, entitled Metis® Relationship Type XML, containing the entire XML specification for that relationship. This provides text for the ultimate metamodel system XML file.

The FIG. 16B portion of RelXML spreadsheet 198 shows rows 3, 4 and 5, which are pieces of a file. A spreadsheet macro takes the information from these three rows to generate the desired XML file. Thus, the content of row 3, column 440; row 4, column 440; and row 5 column 440 is combined to result in the desired metamodel XML file for use in a metamodel system.

The present invention eliminates the problems of having to manually type in the information into the metamodel files or into the spreadsheets arising through the metamodel requirements to capture process. The present invention not only avoids the errors associated with this process but also eliminates essentially all time necessary for manually keying in such information. By virtue of being able to see the metamodel in spreadsheet form, the user is capable of seeing relationships that he would otherwise not be able to see. For example, the cardinality of a particular relationship or position is enabled by the structure of the present invention. By being able to see this information, the user is able to employ this information and then take that information and then use it to go directly into the metamodel file but without any type of manual intervention. This allows the user to go directly into the metamodel system via the metamodel files and demonstrate the visual representation of the relationships that are apparent through the spreadsheet that the metamodel requirements capture process generates. Thus, as a function of the present invention, greater clarity, greater speed, greater economy and the generation of metamodel files that can be used in the metamodel system is improved. Moreover, new relationships can be seen by virtue of the rapid transfer between the spreadsheets generated by the metamodel requirements capture process and the ultimate metamodel system that include 25 the automatically generated metamodel files include.

Accordingly, it is to be understood that the embodiments of the invention herein described are merely illustrative of the application of the principles of the invention. For example, although the present embodiment employs one or more versions of the Metis® metamodeling system, those metamodeling systems made by CaseWise, Popkin, and Slate may also employ one or more embodiment of the present invention. Moreover, the preferred embodiment may be modified or changed by using Visual Basic.Net instead of Excel formulas and VBA formulas. In addition, the approach used for Metis® could be extended to other modeling systems and tools, such as Visio, Popkin, CaseWise, or Slate. Reference herein to details of the illustrated embodiments is not intended to limit the scope of the claims, which themselves recite those features regarded as essential to the invention.

1. A method for automatically generating a plurality of metamodel system files using a set of metamodel requirements derived from a metamodel system, comprising the steps of:
capturing from said metamodel system a set of metamodel requirements;
saving said captured set of metamodel requirements in at least one requirements spreadsheet;
opening said at least one requirements spreadsheet for making accessible said captured set of metamodel requirements;
generating at least one each of an object type spreadsheet, a relationship type mark-up language spreadsheet, and a symbol type spreadsheet by applying a predetermined set of generation instructions to said at least one requirements spreadsheet;
generating from said specified object mark-up language spreadsheet file, relationship type mark-up language spreadsheet, and symbol XML spreadsheet a plurality of metamodel type files.

2. The method of claim 1, further comprising the step of presenting said generated metamodel mark-up language files in real-time for dynamically reviewing and revising said at least one of said object type mark-up language spreadsheet, said relationship type mark-up language spreadsheet and said symbol type mark-up language spreadsheet.

3. The method of claim 1, further comprising the step of opening said at least one requirements spreadsheet in a batch process.

4. The method of claim 1, further comprising the step of presenting in said at least one each of an object type mark-up language spreadsheet a tabular form of a selected set of metamodel components.

5. The method of claim 1, further comprising the step of generating said at least one object type mark-up language spreadsheet, said relationship type mark-up language spreadsheet, and said symbol type mark-up language spreadsheet from said at least one requirements spreadsheet using a plurality of embedded spreadsheet formulas.

6. The method of claim 1, further comprising the step of generating said at least one object type mark-up language spreadsheet, relationship type mark-up language spreadsheet, and symbol type mark-up language spreadsheet from said at least one requirements spreadsheet using a plurality of Visual Basic generation instructions.

7. The method of claim 1, further comprising the step of generating a graphical representation of said capturing step.

8. The method of claim 1, further comprising the step of generating a graphical representation of said step of generating at least one each of an object type mark-up language file, a relationship type file, and a symbol XML file by applying a predetermined set of macros to said at least one spreadsheet;

9. The method of claim 1, further comprising the step of generating a graphical representation of said step of generating at least one each of an object type file, a relationship type file, and a symbol type file by applying a predetermined set of macros to said at least one requirements spreadsheet.

10. A system for automatically generating a plurality of metamodel system files using a set of metamodel requirements derived from a metamodel system, comprising the steps of:
instructions for capturing from said metamodel system a set of metamodel requirements;
instructions for saving said captured set of metamodel requirements in at least one requirements spreadsheet;
instructions for opening said at least one requirements spreadsheet for making accessible said captured set of metamodel requirements;
instructions for generating at least one each of an object type mark-up language spreadsheet, a relationship type mark-up language spreadsheet, and a symbol type mark-up language by applying a predetermined set of macros to said at least one requirements spreadsheet;
instructions for generating from said specified object type mark-up language spreadsheet, relationship type mark-up language spreadsheet, and symbol type mark-up language a plurality of metamodel mark-up language files.

11. The system of claim 10, further comprising instructions for presenting said generated metamodel mark-up language files in real-time for dynamically reviewing and revising at least one of said object type mark-up language spreadsheet, said relationship type mark-up language spreadsheet and said symbol type mark-up language spreadsheet.

12. The system of claim 10, further comprising instructions for opening said at least one requirements spreadsheet in a batch process.

13. The system of claim 10, further comprising instructions for presenting, in said at least one each of an object type mark-up language spreadsheet a tabular form of a selected set of metamodel components.

14. The system of claim 10, further comprising instructions for generating said at least one object type mark-up language spreadsheet, a relationship type mark-up language spreadsheet, and a symbol type mark-up language spreadsheet from said at least one requirements spreadsheet using a plurality of embedded spreadsheet formulas.

15. The system of claim 10, further comprising instructions for generating said at least one each of an object type file, a relationship type file, and a symbol XML file from said at least one requirements spreadsheet using a plurality of Visual Basic generation instructions.

16. The system of claim 10, further comprising instructions for generating a graphical representation of said capturing instructions.

17. The system of claim 10, further comprising instructions for generating a graphical representation of generating at least one each of an object type mark-up language spreadsheet, a relationship type mark-up language spreadsheet, and a symbol mark-up language spreadsheet by applying a predetermined set of macros to said at least one requirements spreadsheet;

18. A storage medium for a computer system comprising instructions for an automated metamodel system file generation system for generating a plurality of metamodel system files, said automated metamodel system file generation system comprising:
instructions for capturing from said metamodel system a set of metamodel requirements;
instructions for saving said captured set of metamodel requirements in at least one requirements spreadsheet;
instructions for opening said at least one requirements spreadsheet for making accessible said captured set of metamodel requirements;
instructions for generating at least one each of an object type mark-up language spreadsheet, a relationship type mark-up language spreadsheet, and a symbol type mark-up language by applying a predetermined set of macros to said at least one requirements spreadsheet;
instructions for generating from said specified object type mark-up language spreadsheet, relationship type mark-up language spreadsheet, and symbol type mark-up language a plurality of metamodel mark-up language files.

19. The storage medium of claim 18, wherein said storage medium comprises a plurality of individual associated storage device media.
